(19) United States
(12) Patent Application Publication
(10) Pub. No.: US 2016/0209041 A1
(43) Pub. Date: Jul. 21, 2016

(54) FUEL VAPORIZER FOR A TURBINE ENGINE COMBUSTOR

(71) Applicant: UNITED TECHNOLOGIES CORPORATION, Hartford,, CT (US)

(72) Inventors: Wendell V. Twelves, Jr., Glastonbury, CT (US); Alexander W. Williams, Windsor Locks, CT (US); Lexia Kironn, Rocky Hill, CT (US); Evan Butcher, Windsor Locks, CT (US); Gary A. Schirtzinger, Glastonbury, CT (US); Joseph Ott, Enfield, CT (US)

(21) Appl. No.: 15/023,580

(22) PCT Filed: Oct. 6, 2014
(86) PCT No.: PCT/US14/59321

§ 371 Date: Mar. 21, 2016

Related U.S. Application Data
(60) Provisional application No. 61/887,694, filed on Oct. 7, 2013.

(51) Int. Cl. F23R 3/30; F02C 7/22

(52) U.S. Cl. CPC F23R 3/30; F02C 7/22; F05D 2220/32; F05D 2240/36

(57) ABSTRACT

An assembly is provided for a turbine engine. The assembly includes a fuel injector and a fuel vaporizer. A nozzle of the fuel injector is adapted to direct fuel to impinge against the fuel vaporizer. The fuel vaporizer is adapted to substantially vaporize the impinging fuel.

### CROSS-REFERENCE TO RELATED APPLICATIONS

This application claims priority to U.S. Provisional Application Ser. No. 61/887,694 filed Oct. 7, 2013, which is hereby incorporated herein by reference in its entirety.

### BACKGROUND OF THE INVENTION

1. Technical Field

This disclosure relates generally to a turbine engine and, more particularly, to a combustor for a turbine engine.

2. Background Information

A combustor section of a turbine engine may include an annular combustor, a plurality of fuel injectors, and a plurality of swirlers. The combustor includes a bulkhead, an inner wall and an outer wall. The bulkhead extends radially between the inner and the outer walls, thereby forming a combustion chamber. The fuel injectors are respectively mated with the swirlers. Each fuel injector is adapted to inject fuel through a respective one of the swirlers and into the combustion chamber. Each swirler is adapted to mix compressed air with the injected fuel, thereby providing a fuel-air mixture for combustion within the combustion chamber.

The fuel injected into the combustion chamber by the fuel injectors may have fuel droplet sizes ranging from about one micron (1 μm) to about two hundred microns (200 μm), or more. The fuel droplets with sizes at the upper end of the foregoing range may be difficult to burn and/or burn efficiently, which may cause delayed and/or incomplete combustion as well as increase turbine engine emissions. To reduce the droplet sizes of the fuel within the combustion chamber, a modern combustor may be configured with one or more recirculation zones. These recirculation zones, however, may have limited effectiveness and may increase the complexity and cost of the combustor.

There is a need in the art for an improved turbine engine combustor.

### SUMMARY OF THE DISCLOSURE

According to an aspect of the invention, an assembly is provided for a turbine engine. The assembly includes a fuel injector and a fuel vaporizer. A nozzle of the fuel injector is adapted to direct fuel to impinge against the fuel vaporizer. The fuel vaporizer is adapted to substantially vaporize the impinging fuel.

According to another aspect of the invention, another assembly is provided for a turbine engine. The assembly includes a fuel injector and an impingement device. A nozzle of the fuel injector is adapted to direct fuel to impinge against the impingement device. The impingement device is adapted to crack the impinging fuel.

According to another aspect of the invention, still another assembly is provided for a turbine engine. The assembly includes a turbine engine combustor, a fuel injector and a fuel vaporizer. The fuel injector is adapted to inject fuel into a chamber of the turbine engine combustor, where the fuel injected into the chamber by the fuel injector impinges against the fuel vaporizer. The fuel vaporizer is adapted to substantially vaporize the injected fuel.

The fuel vaporizer may include a duct and an impingement device within the duct. The nozzle may be adapted to direct the fuel into the duct to impinge against the impingement device.

The fuel vaporizer may include a second duct that circumscribes and is co-axial with the duct.

The impingement device may have a generally conical impingement surface. The nozzle may be adapted to direct the fuel to impinge against the impingement surface.

The impingement device may be configured as or otherwise include a vane that extends inward from a sidewall of the duct.

The impingement device may be configured as or otherwise include a pin that extends inward from a sidewall of the duct.

The impingement device may be one of a plurality of impingement devices within the duct. The nozzle may be adapted to direct the fuel into the duct to impinge against the impingement devices.

The duct may include a sidewall and one or more apertures that extend through the sidewall.

The fuel vaporizer may include a plurality of impingement devices. The nozzle may be adapted to direct the fuel to impinge against the impingement devices.

At least some of the impingement devices may be configured to form an interconnected truss matrix.

A first of the impingement devices may be arranged between the nozzle and a second of the impingement devices. At least some of the impingement devices may also or alternatively be circumferentially arranged around an axis.

The fuel vaporizer may be configured as or otherwise include a duct. The nozzle may be adapted to direct fuel into the duct to impinge against a sidewall of the duct.

The duct may extend along a tortuous trajectory between a duct inlet and a duct outlet.

The fuel vaporizer may include an impingement device that extends inward from the sidewall. The fuel directed into the duct may also impinge against the impingement device.

The impingement device may be one of a plurality of impingement devices that extend inward from the sidewall.

The assembly may include a turbine engine combustor. The nozzle may be adapted to direct the fuel into a chamber of the turbine engine combustor to impinge against the fuel vaporizer.

The foregoing features and the operation of the invention will become more apparent in light of the following description and the accompanying drawings.

### BRIEF DESCRIPTION OF THE DRAWINGS

FIG. 1 is a side cutaway illustration of a geared turbine engine;

FIG. 2 is a side cutaway illustration of a portion of an assembly of the turbine engine;

FIG. 3 is a perspective illustration of a combustor;

FIG. 4 is a side sectional perspective illustration of a fuel vaporizer configured with a fuel injector;

FIG. 5 is a side sectional perspective illustration of another fuel vaporizer configured with a fuel injector;

FIG. 6 is a side sectional perspective illustration of another fuel vaporizer configured with a fuel injector;

FIG. 7 is a side sectional perspective illustration of another fuel vaporizer configured with a fuel injector;

FIG. 8 is a side perspective illustration of another fuel vaporizer configured with a fuel injector;

FIG. 9 is a side perspective illustration of another fuel vaporizer configured with a fuel injector;

FIG. 10 is a side perspective illustration of another fuel vaporizer configured with a fuel injector;

FIG. 11 is a cross-sectional perspective illustration of the fuel vaporizer and fuel injector of FIG. 10;

FIG. 12 is a side perspective illustration of another fuel vaporizer configured with a fuel injector; and

FIG. 13 is a cross-sectional perspective illustration of the fuel vaporizer and fuel injector of FIG. 12.

### DETAILED DESCRIPTION OF THE INVENTION

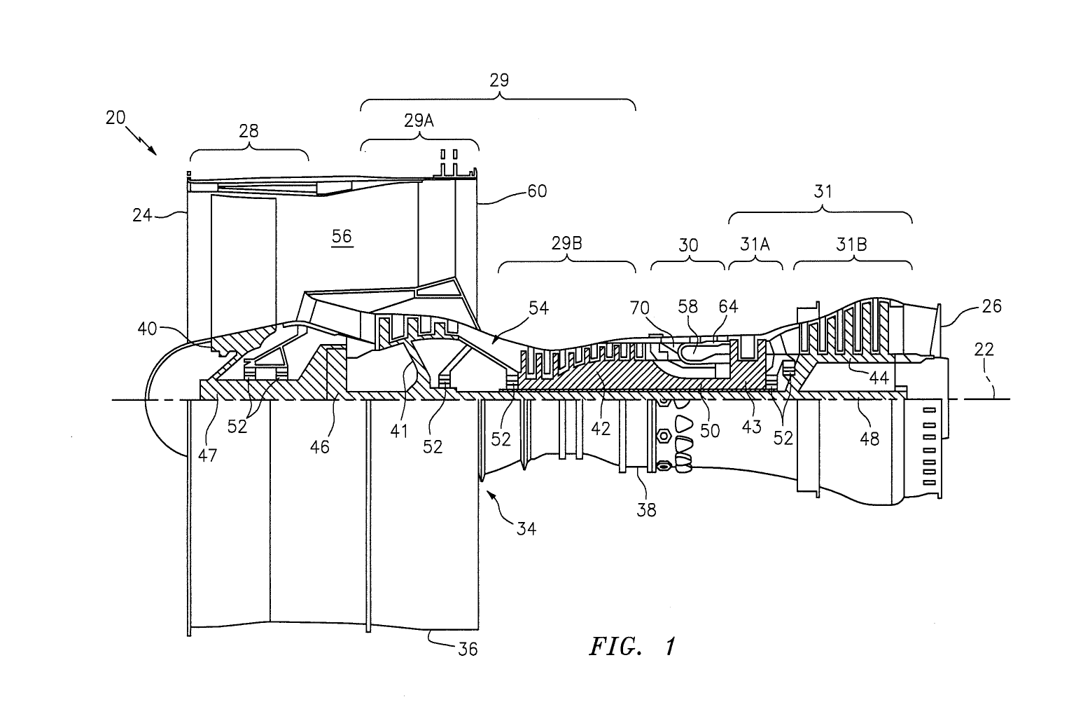

FIG. 1 is a side cutaway illustration of a geared turbine engine 20. This turbine engine 20 extends along an axial centerline 22 between an upstream airflow inlet 24 and a downstream airflow exhaust 26. The turbine engine 20 includes a fan section 28, a compressor section 29, a combustor section 30 and a turbine section 31. The compressor section 29 includes a low pressure compressor (LPC) section 29A and a high pressure compressor (HPC) section 29B. The turbine section 31 includes a high pressure turbine (HPT) section 31A and a low pressure turbine (LPT) section 31B. The engine sections 28-31 are arranged sequentially along the centerline 22 within an engine housing 34, which includes a first engine case 36 (e.g., a fan nacelle) and a second engine case 38 (e.g., a core nacelle).

Each of the engine sections 28, 29A, 29B, 31A and 31B includes a respective rotor 40-44. Each of the rotors 40-44 includes a plurality of rotor blades arranged circumferentially around and connected to (e.g., formed integral with or mechanically fastened, welded, brazed, adhered or otherwise attached to) one or more respective rotor disks. The fan rotor 40 is connected to a gear train 46 (e.g., an epicyclic gear train) through a shaft 47. The gear train 46 and the LPC rotor 41 are connected to and driven by the LPT rotor 44 through a low speed shaft 48. The HPC rotor 42 is connected to and driven by the HPT rotor 43 through a high speed shaft 50. The shafts 47, 48 and 50 are rotatably supported by a plurality of bearings 52. Each of the bearings 52 is connected to the second engine case 38 by at least one stator such as, for example, an annular support strut.

Air enters the turbine engine 20 through the airflow inlet 24, and is directed through the fan section 28 and into an annular core gas path 54 and an annular bypass gas path 56. The air within the core gas path 54 may be referred to as “core air”. The air within the bypass gas path 56 may be referred to as “bypass air”.

The core air is directed through the engine sections 29-31 and exits the turbine engine 20 through the airflow exhaust 26. Within the combustor section 30, fuel is injected into an annular combustion chamber 58 and mixed with the core air. This fuel-core air mixture is ignited to power the turbine engine 20 and provide forward engine thrust. The bypass air is directed through the bypass gas path 56 and out of the turbine engine 20 through a bypass nozzle 60 to provide additional forward engine thrust. Alternatively, at least some of the bypass air may be directed out of the turbine engine 20 through a thrust reverser to provide reverse engine thrust.

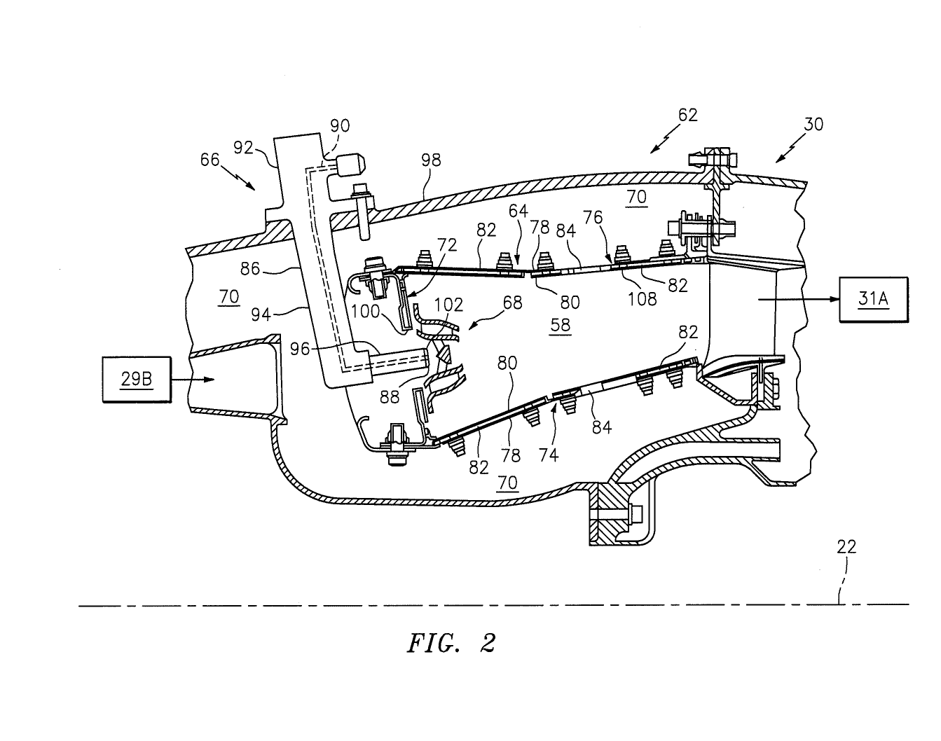

FIG. 2 illustrates an assembly 62 of the turbine engine 20. This assembly 62 includes an annular turbine engine combustor 64, one or more fuel injectors 66, and one or more fuel vaporizers 68.

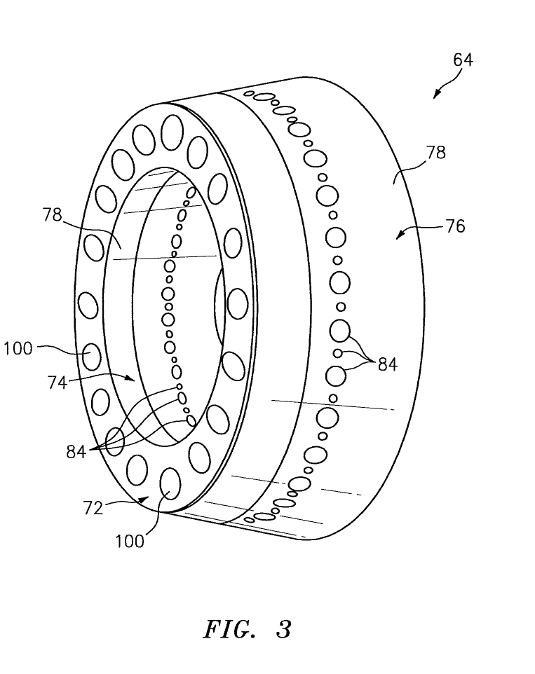

The combustor 64 is arranged within an annular plenum 70 of the combustor section 30. Referring to FIGS. 2 and 3, the combustor 64 includes an annular combustor bulkhead 72, a tubular combustor inner wall 74, and a tubular combustor outer wall 76. The bulkhead 72 extends radially between and is connected to the inner wall 74 and the outer wall 76. The inner wall 74 and the outer wall 76 each extends axially along the centerline 22 from the bulkhead 72 towards the turbine section 31A, thereby defining the combustion chamber 58.

Referring to FIG. 2, the inner wall 74 and the outer wall 76 may each have a multi-walled structure; e.g., a hollow dual-walled structure. The inner wall 74 and the outer wall 76 of FIG. 2, for example, each includes a tubular combustor shell 78, a tubular combustor heat shield 80, and one or more cooling cavities 82 (e.g., impingement cavities). These cooling cavities 82 fluidly couple cooling apertures (e.g., impingement apertures) in the shell 78 with cooling apertures (e.g., effusion apertures) in the heat shield 80. The inner wall 74 and the outer wall 76 also each include a plurality of quench apertures 84, which are arranged circumferentially around the centerline 22.

The fuel injectors 66 are disposed circumferentially around the centerline 22. Each of the fuel injectors 66 includes an injector housing 86, a nozzle 88 and at least one fuel conduit 90. The injector housing 86 includes a base 92, a stem 94 and a tip 96. The base 92 mounts the fuel injector 66 to a case 98 of the turbine engine 20. The stem 94 is connected to and extends radially between the base 92 and the tip 96. The tip 96 extends axially out from the stem 94, through (or into) an injector aperture 100 in the bulkhead 72, to the nozzle 88. An aperture 102 in the nozzle 88 is fluidly coupled with the fuel conduit 90. The nozzle 88 is adapted to inject fuel through the nozzle aperture 102 and into the combustion chamber 58 as described below in further detail.

Each of the fuel vaporizers 68 is circumferentially aligned with a respective one of the fuel injectors 66. Each fuel vaporizer 68, for example, may be substantially co-axial with the tip 96 and/or the nozzle 88 (e.g., the nozzle aperture 102) of a respective one of the fuel injectors 66. Each fuel vaporizer 68 may be mounted to a respective one of the fuel injectors 66 (e.g., the tip 96) and/or the combustor 64 (e.g., the bulkhead 72 and/or the wall(s) 74, 76) by one or more attachments, which are not shown in FIG. 2 for ease of illustration. Examples of an attachment include, but are not limited to, a strut, a vane, a fastener, and a moveable joint such as, for example, a bushing or a bearing. Alternatively, each fuel vaporizer 68 may be bonded (e.g., welded, brazed or adhered) directly to the fuel injector 66 and/or the combustor 64.

Each fuel vaporizer 68 includes one or more impingement devices (e.g., bodies, protrusions and/or ducts), which are adapted to substantially vaporize and/or crack the fuel being injected into the combustion chamber 58 by a respective one of the fuel injectors 66. One or more of the fuel injectors 66, for example, may each inject the fuel into the combustion chamber 58 with droplet sizes ranging between, for example, about one micron (1 μm) and about two hundred microns (200 μm). The impingement device(s) of each fuel vaporizer 68 are adapted to change the injected fuel droplets from a liquid state to a gaseous state and thereby vaporize some or all of the injected fuel. The impingement device(s) of each fuel vaporizer 68 are also or alternatively adapted to reduce the molecular size of the injected fuel droplets and thereby crack some or all of the injected fuel. The term “crack” may describe reducing the molecular size of the fuel from a larger molecular weight to a smaller molecular weight, opposed to reducing fuel droplet size as is done during atomization. The impingement device(s) of each fuel vaporizer 68 may also be adapted to atomize the injected fuel thereby reducing the droplet sizes of at least some (e.g., between about 25 and about 100 percent) of the injected fuel below, for example, about ten microns (10 μm).

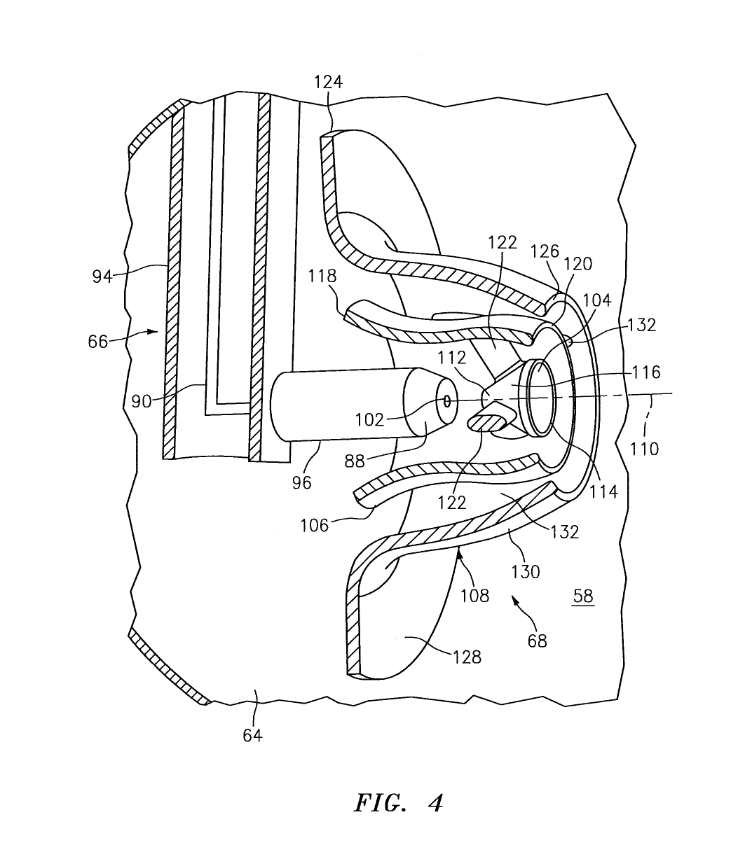

FIGS. 4-13 illustrate a portion of the combustor section 30 configured with various fuel vaporizer 68 embodiments. For ease of illustration, the combustor 64 of FIGS. 4-13 is shown without the bulkhead 72.

The fuel vaporizer 68 of FIG. 4 includes an impingement device 104, an inner duct 106 and an outer duct 108. The impingement device 104 may be substantially co-axial with the tip 96 and the nozzle aperture 102. The impingement device 104 is configured as a (e.g., hollow) generally conical body. The impingement device 104 extends along an axis 110 between an upstream end 112 and a downstream end 114. The impingement device 104 has an outer generally conical impingement surface 116, which radially tapers to a tip at the upstream end 112.

The inner duct 106 circumscribes and may be substantially co-axial with the impingement device 104. The inner duct 106 extends along the axis 110 between an upstream end 118 and a downstream end 120, which may be substantially axially aligned with the downstream end 114. A radius of the inner duct 106 at the upstream end 118 is greater than a radius of the inner duct 106 at the downstream end 120. The inner duct 106 is connected to the impingement device 104 by one or more attachments 122; e.g., vanes. The attachments 122 are arranged circumferentially around the axis 110, and extend radially between the impingement device 104 and the inner duct 106.

The outer duct 108 circumscribes and may be substantially co-axial with the inner duct 106. The outer duct 108 extends along the axis 110 between an upstream end 124 and a downstream end 126, which may be substantially axially aligned with the downstream end 120. The outer duct 108 includes a flange portion 128 and a duct portion 130. The flange portion 128 is located at the upstream end 124, and extends radially out from the duct portion 130. The duct portion 130 extends along the axis 110 from the flange portion 128 to the downstream end 126. A radius of the duct portion 130 at the upstream end 124 is greater than a radius of the duct portion 130 at the downstream end 126. The outer duct 108 is connected to the inner duct 106 by one or more attachments 132; e.g., vanes. The attachments 132 are arranged circumferentially around the axis 110, and extend radially between the inner duct 106 and the outer duct 108.

During operation of the turbine engine assembly 62 of FIG. 2, the plenum 70 receives compressed core air from the HPC section 29B. The plenum 70 provides at least some of the received core air to the combustor 64 for the combustion process. Some of the core air within the plenum 70, for example, is directed into the combustion chamber 58 through the injector apertures 100 and the fuel vaporizers 68. This portion of the core air mixes with the fuel injected by the fuel injectors 66, thereby providing the fuel-air mixture. The quench apertures 84 direct additional core air from the plenum 70 into the combustion chamber 58 to lean out the fuel-core air mixture. The fuel-core air mixture is ignited within the combustion chamber 58 by one or more igniters to power the turbine engine 20.

Referring to FIG. 4, thermal energy is released as a byproduct of the foregoing combustion process. Some of this thermal energy may radiate upstream through the combustion chamber 58 and heat each fuel vaporizer 68 and its impingement device 104. The fuel injected into the combustion chamber 58 by the nozzle 88 impinges against the heated impingement device 104 (e.g., the impingement surface 116), thereby vaporizing and/or cracking (e.g., reducing the mean molecule size) some or substantially all of the impinging fuel. Thermal energy radiating and/or conducted from the impingement device 104, for example, may flash boil some of the impinging fuel. Associated heat of vaporization may cool the impingement device 104 and prevent overheating. In addition, the force of the fuel impinging against the impingement surface 116 may cause some of the impinging fuel droplets to crack.

The fuel-core air mixture within the inner duct 106 and/or immediately downstream of each fuel vaporizer 68 may be relatively stoichiometrically rich to prevent or reduce pre-ignition of the fuel-core air mixture at (e.g., in, adjacent or proximate) the fuel vaporizers 68. The radius of the inner duct 106 at the upstream end 118 may be sized, for example, to meter (e.g., limit) the flow of core air into the inner duct 106 from the plenum 70. The radius of the duct portion 130 at the upstream end 124 may be sized to meter (e.g., limit) the flow of the core air into the outer duct 108 from the plenum 70. The radius of the inner duct 106 and/or the outer duct 108 at its downstream end 120, 126 may also be sized to create a pressure drop that accelerates the core air through the duct 106, 108 to facilitate mixing of the core air with the fuel.

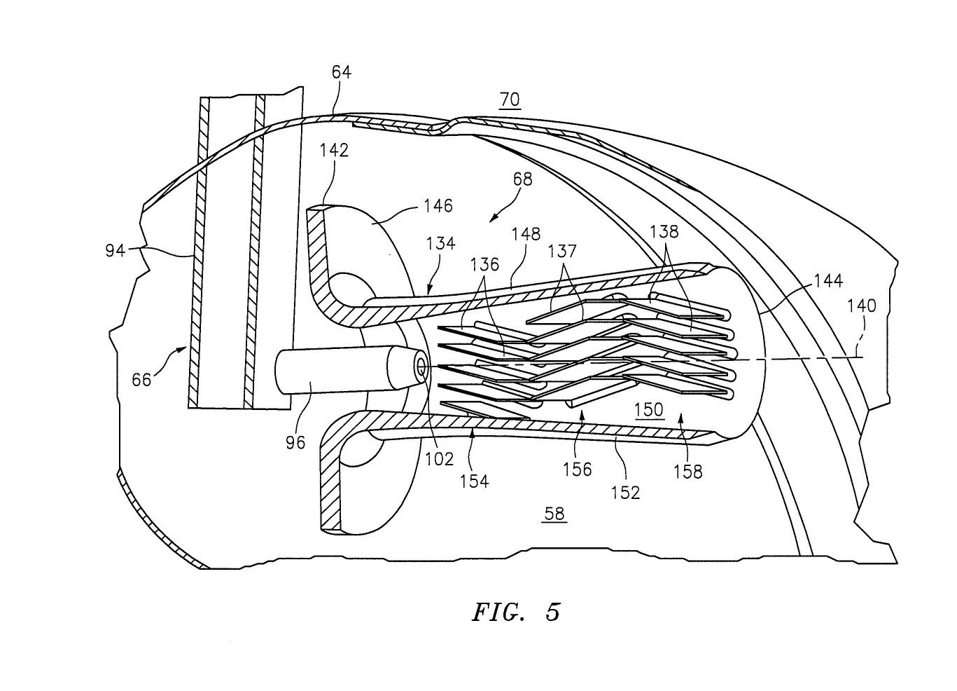

The fuel vaporizer 68 of FIG. 5 includes a duct 134 and one or more impingement devices 136-138, which are arranged radially within the duct 134. The duct 134 may be substantially co-axial with the tip 96 and the nozzle aperture 102. The duct 134 extends along an axis 140 between an upstream end 142 and a downstream end 144. The duct 134 includes a flange portion 146 and a duct portion 148. The flange portion 146 is located at the upstream end 142, and extends radially out from the duct portion 148. The duct portion 148 extends along the axis 140 from the flange portion 146 to the downstream end 144. A radius of the duct portion 148 at the upstream end 142 is less than a radius of the duct portion 148 at the downstream end 144, thereby reducing airflow impedance through the duct 134 and around the impingement devices 136-138.

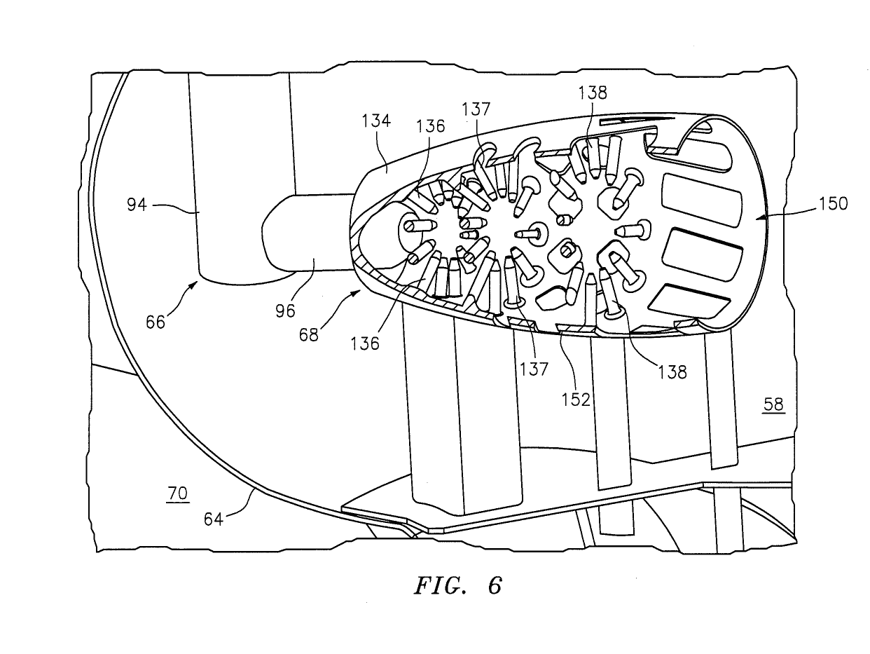

Each of the impingement devices 136-138 is configured as a vane. However, one or more of the impingement devices 136-138 may alternatively each be configured as a pin as illustrated in FIG. 6, or any other type of protrusion. Referring again to FIG. 5, each impingement device 136-138 extends through a bore 150 of the duct portion 148; e.g., laterally (or radially) between opposing portions of a sidewall 152 of the duct 134. However, one or more of the impingement devices 136-138 may alternatively each extend radially (or laterally) inward from the sidewall 152 and partially into the bore 150 as illustrated in FIG. 6.

Referring to FIG. 5, the impingement devices 136 are arranged into an impingement and/or vaporization upstream stage 154. The impingement devices 137 are arranged into an impingement and/or vaporization intermediate stage 156, which is downstream of the upstream stage 154. The impingement devices 138 are arranged into an impingement and/or vaporization downstream stage 158, which is downstream of the intermediate stage 156. The impingement devices 136, 137, 138 in each stage 154, 156, 158 may be staggered relative to the impingement devices 136, 137, 138 in an adjacent one of the stages 154, 156, 158.

During operation, each impingement device 136-138 may vaporize and/or crack fuel droplets injected into the combustion chamber 58 by a respective one of the fuel injectors 66 in a similar manner as described above. In particular, the upstream stage 154 may vaporize and/or crack a first portion of the injected fuel. The intermediate stage 156 may vaporize and/or crack a second portion of the injected fuel. The downstream stage 158 may vaporize and/or crack any remaining portion of the injected fuel. In addition, the duct portion 148 may also function as an impingement device where, for example, one or more of the impingement devices 136-138 cause fuel droplets to travel radially outward and impinge against the sidewall 152.

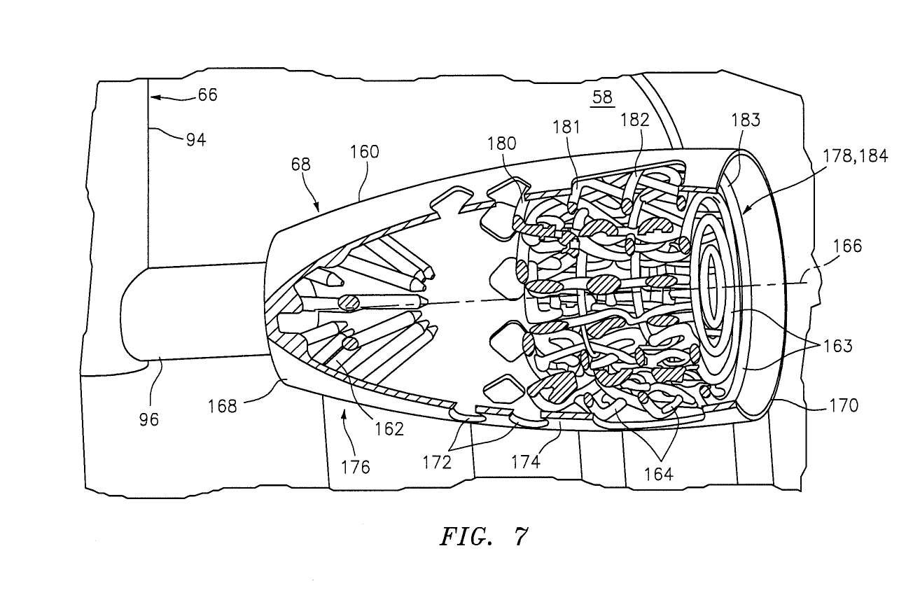

The fuel vaporizer 68 of FIG. 7 includes a duct 160 and one or more impingement devices 162-164, which are arranged radially within the duct 160. The duct 160 may be substantially co-axial with the tip 96 and the nozzle aperture. The duct 160 extends along an axis 166 between an upstream end 168 and a downstream end 170. A radius of the duct 160 at the upstream end 168 is less than a radius of the duct 160 at the downstream end 170, thereby reducing airflow impedance through the duct 160 and around the impingement devices 162-164. The duct 160 may include one or more apertures 172, each of which extends radially through a sidewall 174 of the duct 160. The apertures 172 are arranged circumferentially around and/or axially along the axis 166. These apertures 172 may provide additional airflow into the duct 160, thereby leaning out the fuel-core air mixture. The apertures 172 may also reduce the temperature of the duct 160.

Each of the impingement devices 162 is configured as a pin. However, one or more of the impingement devices 162 may alternatively each be configured as a vane, or any other type of protrusion. Each impingement device 162 extends radially (or laterally) inward from the sidewall 174 and partially into a bore of the duct 160. However, one or more of the impingement devices 162 may alternatively each extend laterally (or radially) through the bore. The impingement devices 162 are arranged circumferentially around the axis 166 at, for example, the upstream end 168. The impingement devices 162 provide an impingement and/or vaporization upstream stage 176.

Each of the impingement devices 163 and 164 is configured as a filament of an interconnected truss matrix 178. The impingement devices 163, for example, are configured as one or more filament sets 180-183 of one or more co-axial filament rings. The filament set 180 is upstream of the filament set 181, which is upstream of the filament set 182, which is upstream of the filament set 183. The impingement devices 164 are configured as stanchion filaments that extend radially and/or axially between and connect respective impingement devices 163 and 164. One or more of the impingement devices 163 also connect the truss matrix 178 to the duct 160. The truss matrix 178, however, may alternatively be connected to the duct 160 by one or more attachments. The truss matrix 178 provides an impingement and/or vaporization downstream stage 184, which is downstream of the upstream stage 176.

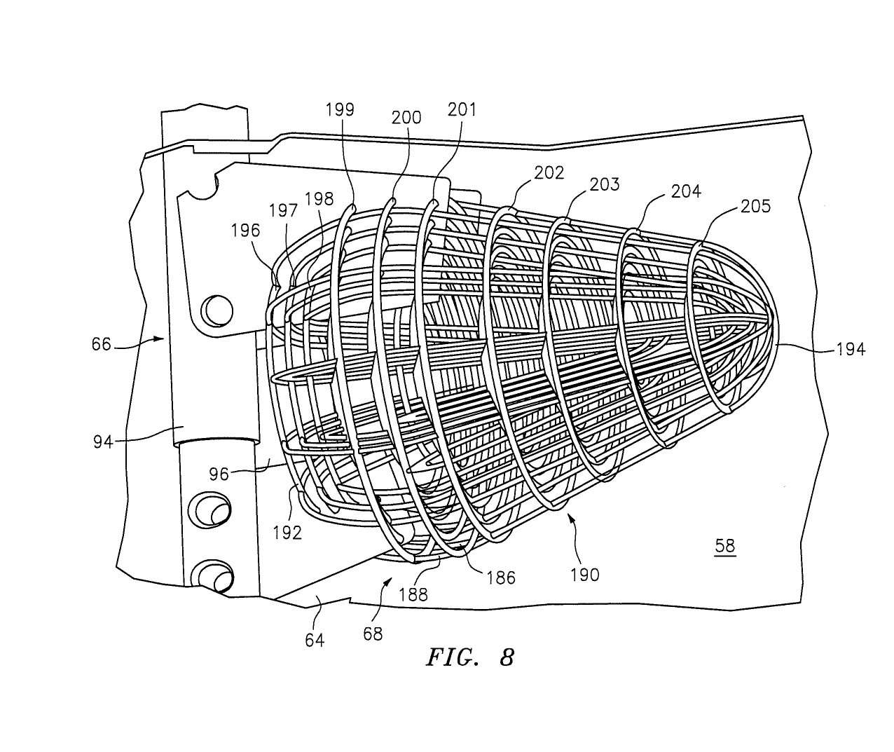

The fuel vaporizer 68 of FIG. 8 includes one or more impingement devices 186 and 188. Each of these impingement devices 186 and 188 is configured as a filament of an interconnected truss matrix 190. This truss matrix 190 has a generally bulbous geometry, and extends axially between an upstream end 192 and a downstream end 194. The impingement devices 186 are configured as one or more filament sets 196-205 of one or more co-axial filament rings. The filament set 196 is upstream of the filament set 197, which is upstream of the filament set 198, etc. An outer radius of the filament set 196 at the upstream end 192 and an outer radius of the filament set 205 proximate the downstream end 194 may be less than an outer radius of a midstream filament set 199-203. The impingement devices 188 are configured as stanchion filaments that extend radially and/or axially along a tortuous trajectory between and connect respective impingement devices 186 and 188.

The fuel vaporizer 68 of FIG. 9 includes at least one impingement device 206, which includes a duct 208 and an annular flange 210. The duct 208 extends along a tortuous trajectory between a duct inlet (not shown) and a duct outlet 212. The duct 208, for example, may have a curlicue type geometry that turns about three hundred and sixty degrees (360°). The duct inlet may be substantially co-axial with and receive the tip 96 and the nozzle aperture. The duct outlet 212 is axially offset from the duct inlet, the tip 96 and the nozzle aperture. A radius of the duct inlet may be substantially equal to (or different than) a radius of the duct outlet 212. The flange 210 is connected to the duct 208 at the duct inlet.

During operation, thermal energy generated as a byproduct of the combustion process radiantly heats the duct 208. The fuel injected into the combustion chamber 58 by the nozzle impinges against a sidewall 214 of the heated duct 208, thereby vaporizing and/or cracking at least some of the impinging fuel. Thermal energy radiating and/or conducted from the sidewall 214, for example, may flash boil some of the impinging fuel. In addition, the force of the fuel impinging against the sidewall 214 may cause some of the impinging fuel droplets to crack.

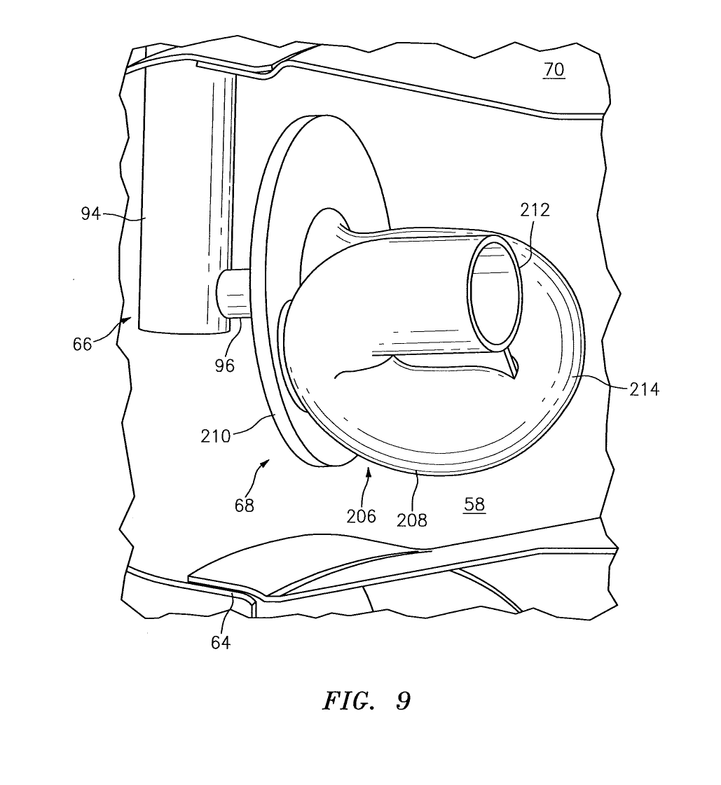

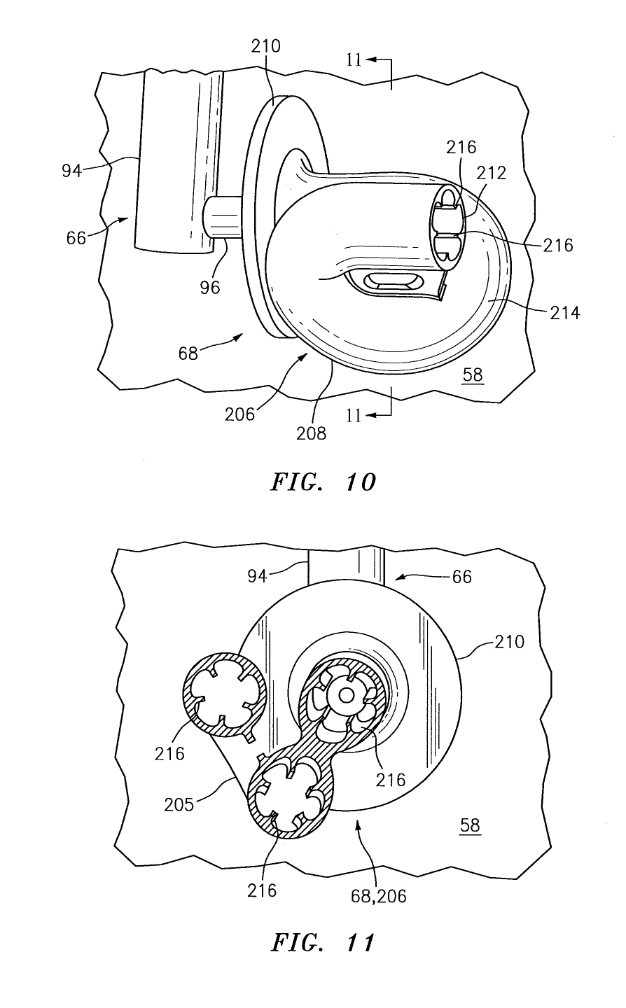

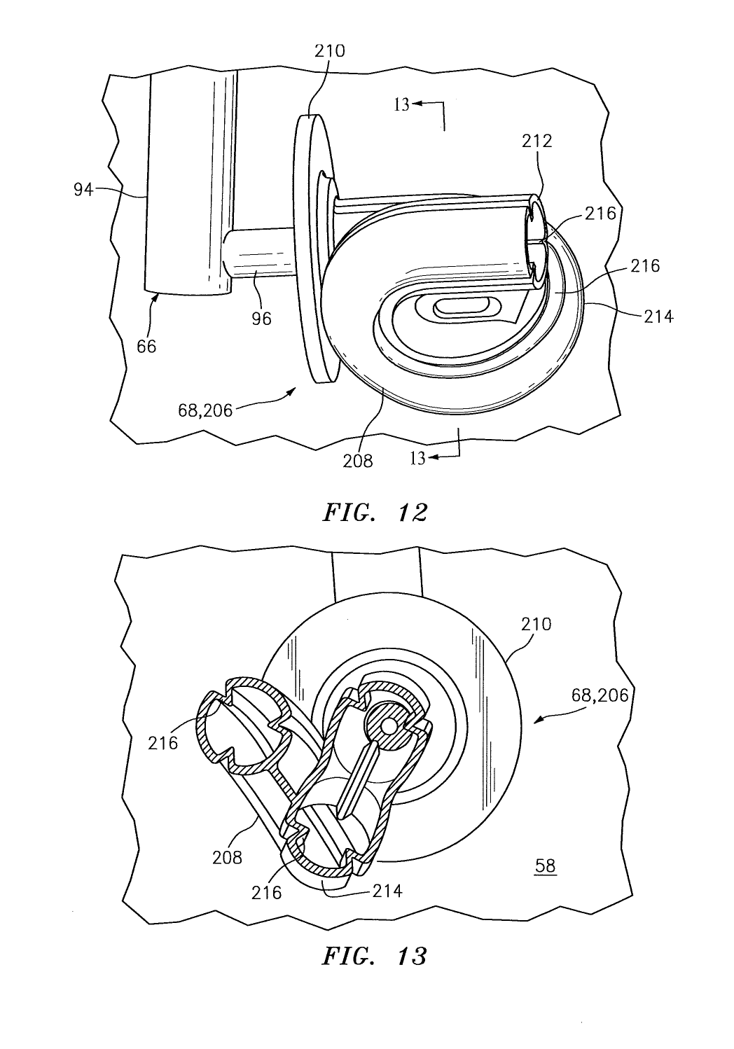

Referring to FIGS. 10-13, in some embodiments, the fuel vaporizer 68 may include one or more additional impingement devices 216. One or more of these impingement devices 216 may each be configured as a rail, or any other type of protrusion (e.g., a pin, a vane, a filament, etc.) that increases surface area within the duct 208 available for fuel impingement and/or strengthens the sidewall 214. The impingement device 216 may extend along the tortuous trajectory of the duct 208 between the duct inlet and the duct outlet 212 as illustrated in FIGS. 11-13. Alternatively, the impingement device 216 may extend along a portion of the tortuous trajectory of the duct 208, and/or spiral around the tortuous trajectory of the duct 208. In the embodiment of FIGS. 10 and 11, the impingement device 216 is configured as a body that extends inward from the sidewall 214 into a bore of the duct 208. In the embodiment of FIGS. 12 and 13, the impingement device 216 is configured as a portion of the sidewall 214 that extends inwards from adjacent outer portions of the sidewall 214.

One or more of the fuel vaporizers 68 may each be formed using additive manufacturing. One or more of the fuel vaporizers 68 may alternatively or additionally each be formed using a casting process, a machining process, a milling process, and/or any other type of manufacturing process. One or more of the fuel vaporizers 68 may each be formed from metallic material such as, for example, an Inconel high temperature refractory alloy. One or more of the fuel vaporizers 68, of course, may alternatively be formed from metallic materials and/or non-metallic materials other than those described above.

The terms “upstream”, “downstream”, “inner” and “outer” are used to orientate the components of the turbine engine assembly 62 described above relative to the turbine engine 20 and its axis 22. A person of skill in the art will recognize, however, one or more of these components may be utilized in other orientations than those described above. The present invention therefore is not limited to any particular spatial orientations.

The turbine engine assembly 62 may be included in various turbine engines other than the one described above. The assembly 62, for example, may be included in a geared turbine engine where a gear train connects one or more shafts to one or more rotors in a fan section, a compressor section and/or any other engine section. Alternatively, the assembly 62 may be included in a turbine engine configured without a gear train. The assembly 62 may be included in a geared or non-geared turbine engine configured with a single spool, with two spools (e.g., see FIG. 1), or with more than two spools. The turbine engine may be configured as a turbofan engine, a turbojet engine, a propfan engine, or any other type of turbine engine. The present invention therefore is not limited to any particular types or configurations of turbine engines.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. Accordingly, the present invention is not to be restricted except in light of the attached claims and their equivalents.

What is claimed is:

1. An assembly for a turbine engine, the assembly comprising:
a fuel injector including a nozzle; and
a fuel vaporizer;
the nozzle adapted to direct fuel to impinge against the fuel vaporizer; and
the fuel vaporizer adapted to substantially vaporize the impinging fuel.

2. The assembly of claim 1, wherein
the fuel vaporizer includes a duct and an impingement device within the duct; and
the nozzle is adapted to direct the fuel into the duct to impinge against the impingement device.

3. The assembly of claim 2, wherein the fuel vaporizer further includes a second duct that circumscribes and is co-axial with the duct.

4. The assembly of claim 2, wherein
the impingement device has a generally conical impingement surface; and
the nozzle is adapted to direct the fuel to impinge against the impingement surface.

5. The assembly of claim 2, wherein the impingement device comprises a vane that extends inward from a sidewall of the duct.

6. The assembly of claim 2, wherein the impingement device comprises a pin that extends inward from a sidewall of the duct.

7. The assembly of claim 2, wherein
the impingement device is one of a plurality of impingement devices within the duct; and
the nozzle is adapted to direct the fuel into the duct to impinge against the impingement devices.

8. The assembly of claim 7, wherein at least some of the impingement devices are configured to form an interconnected truss matrix.

9. The assembly of claim 2, wherein the duct includes a sidewall and one or more apertures that extend through the sidewall.

10. The assembly of claim 1, wherein
the fuel vaporizer includes a plurality of impingement devices; and
the nozzle is adapted to direct the fuel to impinge against the impingement devices.

11. The assembly of claim 10, wherein at least some of the impingement devices are configured to form an interconnected truss matrix.

12. The assembly of claim 10, wherein a first of the impingement devices is arranged between the nozzle and a second of the impingement devices.

13. The assembly of claim 10, wherein at least some of the impingement devices are circumferentially arranged around an axis.

14. The assembly of claim 1, wherein
the fuel vaporizer includes a duct; and
the nozzle is adapted to direct fuel into the duct to impinge against a sidewall of the duct.

15. The assembly of claim 14, wherein the duct extends along a tortuous trajectory between a duct inlet and a duct outlet.

16. The assembly of claim 14, wherein the fuel vaporizer includes an impingement device that extends inward from the sidewall, and the fuel directed into the duct also impinges against the impingement device.

17. The assembly of claim 16, wherein the impingement device is one of a plurality of impingement devices that extend inward from the sidewall.

18. The assembly of claim 1, further comprising a turbine engine combustor including a chamber, wherein the nozzle is adapted to direct the fuel into the chamber to impinge against the fuel vaporizer.

19. An assembly for a turbine engine, the assembly comprising:
a fuel injector including a nozzle; and
an impingement device;
the nozzle adapted to direct fuel to impinge against the impingement device; and
the impingement device adapted to crack the impinging fuel.

20. An assembly for a turbine engine, the assembly comprising:
a turbine engine combustor including a chamber;
a fuel injector adapted to inject fuel into the chamber; and
a fuel vaporizer adapted to substantially vaporize the injected fuel;
wherein the fuel injected into the chamber by the fuel injector impinges against the fuel vaporizer.
